(19) United States
(12) Patent Application Publication
(10) Pub. No.: US 2020/0061646 A1
(43) Pub. Date: Feb. 27, 2020

(54) ROADSIDE SPRAY APPARATUS

(71) Applicant: Corey CRAIG, Auburn, AL (US)

(72) Inventor: Corey CRAIG, Auburn, AL (US)

(21) Appl. No.: 16/549,255

(22) Filed: Aug. 23, 2019

Related U.S. Application Data
(60) Provisional application No. 62/722,077, filed on Aug. 23, 2018.

(51) Int. Cl. B05B 7/24; B05B 7/00; A01M 21/04; A01M 7/00

(52) U.S. Cl. CPC B05B 7/2491; A01M 7/006; A01M 21/043; B05B 7/0093

(57) ABSTRACT

A roadside spray apparatus for spraying herbicides on roadsides and other right-of-ways including a spray head assembly. In example embodiments, the spray head assembly includes one or more spray nozzle assemblies for discharging a liquid. The one or more spray nozzle assemblies include a main body portion, an inner reducer portion and a secondary body portion, wherein the main body portion includes an orifice in communication with atmospheric air so as to allow for the introduction of air within the spray nozzle assembly such that the liquid is substantially oxygenated, thereby allowing for the discharging of air-filled liquid droplets with minimal atomization.

### CROSS-REFERENCE TO RELATED APPLICATION

This application claims the benefit of U.S. Provisional Patent Application Ser. No. 62/722,077 filed Aug. 23, 2018, the entirety of which is hereby incorporated herein by reference for all purposes.

### TECHNICAL FIELD

The present invention relates to a spray apparatus and more particularly to an apparatus for spraying herbicides on roadsides and other right-of-ways.

### BACKGROUND OF THE INVENTION

Roadside spray apparatuses are known. Commonly, one or more standard nozzles are provided on a spray apparatus for discharging herbicides along roadsides, railway beds, right-of-ways, and other areas where it is desired to apply a herbicide, for example, so as to eliminate unwanted brush and vegetation. In some cases, the spray apparatus is provided with an electric vibrator or vibration system such that the discharge of herbicide from the standard nozzle(s) provides droplet separation and minimizes drift. Continuous improvements to spray apparatuses and herbicide applicators are sought. It is to the provision of an improved roadside spray apparatus and methods thereof meeting these and other needs that the present invention is primarily directed.

### SUMMARY OF THE INVENTION

In example embodiments, the present invention provides a spray apparatus or herbicide applicator including at least one spray nozzle incorporating a venturi or air induction component.

In one aspect, the invention relates to a roadside spray apparatus substantially as described and shown herein. In another aspect, the present invention relates to a spray nozzle assembly for use with a roadside spray apparatus substantially as described and shown herein.

In another aspect, the invention relates to a venturi spray nozzle assembly. In example embodiments, the venturi spray nozzle assembly includes a main body portion, an inner reducer portion, and a second body portion. In example embodiments, the main body portion, the inner reducer portion and the secondary body portion each comprise a conduit extending therethrough. In example embodiments, an end of the secondary body portion is configured for coupling engagement with an end of the main body portion so as to contain the inner reducer portion within the conduit of the main body portion, In example embodiments, the main body portion includes an orifice so as to permit the entrance of a gas within the conduit of the conduit of the main body portion.

In example embodiments, with a fluid being pumped through the conduits at a substantially high flow rate, air is pulled through the orifice and mixed together with the fluid flowing therethrough so as to output substantially large oxygenated fluid droplets with minimal atomization.

In example embodiments, the assembly optionally includes a washer or gasket positioned between the inner reducer portion and the conduit of the main body portion.

In yet another aspect, the present invention relates to a roadside spray apparatus including a mounting portion, a distribution portion and a nozzle head assembly. The distribution portion connects to the mounting portion and the nozzle head assembly is pivotally mounted to the distribution portion. In example embodiments, an actuator connects between the mounting portion and/or distribution portion and the nozzle head assembly such that extension and retraction of the actuator causes pivoting of the nozzle head assembly.

In example embodiments, the nozzle assembly includes a frame assembly and an arcuate registration plate mounted to the frame assembly, the registration plate including one or more nozzles connected therewith, wherein at least one of the one or more nozzles includes an air induction nozzle.

In example embodiments, at least one of the one or more nozzles includes a straight stream nozzle. In example embodiments, the nozzle head assembly further includes a spray nozzle attached to the end of the at least one air induction nozzle, the spray nozzle including a flat spray pattern.

In example embodiments, the air induction nozzle produces a total spray volume for which at least about 50% thereof includes droplets of equal or lesser diameter than between about 1500-1800 microns. In example embodiments, the total spray volume for which at least about 50% thereof includes droplets of equal or lesser diameter than between about 1550-1600 microns. In example embodiments, the total spray volume for which at least about 50% thereof includes droplets of equal or lesser diameter than between about 1585-1599 microns. In example embodiments, the straight stream nozzle produces a total spray volume for which at least about 50% thereof includes droplets of equal or lesser diameter than between about 700-1220 microns. In example embodiments, the straight stream nozzle produces a total spray volume for which at least about 10% thereof includes droplets of equal or lesser diameter than between about 360-1050 microns.

In example embodiments, the registration plate includes four air induction nozzles and ten straight stream nozzles. In example embodiments, the at least one air induction nozzle is generally mounted to the registration plate along a plane that is generally at the midpoint of its lengthwise dimension. In example embodiments, the straight stream nozzles are generally mounted to the arcuate registration plate generally near each other in groups of between two to four, wherein at least two groups of straight stream nozzles mount along at least a portion of the arcuate registration plate, wherein the at least two groups of straight stream nozzles are spaced relative to each other and also spaced apart from the air induction nozzles.

In yet another aspect, the present invention relates to a venturi spray nozzle assembly including a main body portion, an inner reducer portion and a secondary body portion. The main body portion includes a conduit extending therethrough. The inner reducer portion includes a conduit extending therethrough and being configured for fitting within at least a portion of the conduit of the main body portion. The secondary body portion includes a first end and a second end and a conduit extending therethrough. The first end of the secondary body portion being configured for coupling engagement with an end of the main body portion so as to contain the inner reducer portion within the conduit of the main body portion. In example embodiments, the main body portion includes an orifice so as to permit the entrance of a gas within the conduit of the conduit of the main body portion.

In example embodiments, with a fluid being pumped through the conduits at a substantially high flow rate, air is pulled through the orifice and mixed together with the fluid flowing therethrough so as to output substantially large oxygenated fluid droplets with minimal atomization. In example embodiments, the venturi spray nozzle further includes a washer or gasket positioned between the inner reducer portion and the conduit of the main body portion. In example embodiments, the venturi spray nozzle further includes a spray nozzle attached to the second end of the secondary body portion, the spray nozzle including a flat spray pattern.

In example embodiments, the air induction nozzle produces a total spray volume for which at least about 50% thereof includes droplets of equal or lesser diameter than between about 1550-1600 microns. In example embodiments, the total spray volume for which at least about 50% thereof includes droplets of equal or lesser diameter than between about 1585-1599 microns. In example embodiments, the venturi spray nozzle assembly further includes at least one straight stream nozzle, the straight stream nozzle producing a total spray volume for which at least about 50% thereof includes droplets of equal or lesser diameter than between about 700-1220 microns. In example embodiments, the venturi spray nozzle assembly further includes at least one straight stream nozzle, the straight stream nozzle producing a total spray volume for which at least about 10% thereof includes droplets of equal or lesser diameter than between about 360-1050 microns.

In another aspect, the present invention relates to a method of applying a fluid to a ground surface including providing a roadside spray apparatus, the roadside spray apparatus including a mounting portion, a distribution portion, and a nozzle head assembly pivotally mounted to the distribution portion; providing at least one air induction nozzle for attachment to the nozzle head assembly; providing at least one straight stream nozzle for attachment to the nozzle head assembly, the straight stream nozzle being at least partially spaced apart from the air induction nozzle; fluidly connecting the at least one air induction nozzle and at least one straight stream nozzle to the distribution portion; fluidly connecting the distribution portion to a pump, the pump fluidly connected to a tank including a liquid; mounting the roadside spray apparatus to a wheeled vehicle; and pumping the liquid from the tank, through the pump, to the distribution portion, and further through the at least one air induction nozzle and the at least one straight stream nozzle so as to produce at least two swaths of the liquid.

These and other aspects, features and advantages of the invention will be understood with reference to the drawing figures and detailed description herein, and will be realized by means of the various elements and combinations particularly pointed out in the appended claims. It is to be understood that both the foregoing general description and the following brief description of the drawings and detailed description of the invention are exemplary and explanatory of preferred embodiments of the invention, and are not restrictive of the invention, as claimed.

### BRIEF DESCRIPTION OF THE DRAWINGS

FIG. 1 shows a perspective view of a roadside spray apparatus according to an example embodiment of the present invention, and showing a spray head assembly discharging a plurality of swaths at various distances therefrom.

FIG. 2 shows a close-up detailed view of the spray head assembly of FIG. 1 and the swaths being discharged therefrom.

FIG. 3 shows a top perspective view of the spray head assembly of FIG. 1.

FIG. 4 shows a bottom perspective view of the spray head assembly of FIG. 3.

FIG. 5 shows a front plan view of the spray head assembly of FIG. 3.

FIG. 6 shows a perspective assembly view of a spray nozzle assembly shown in FIG. 5.

FIG. 7 shows a cross-sectional view of the spray nozzle assembly of FIG. 6 in an assembled configuration.

FIGS. 8-10 show line charts displaying the droplet sizes of the swaths being discharged from the spray head assembly according to example embodiments of the present invention.

### DETAILED DESCRIPTION OF EXAMPLE EMBODIMENTS

The present invention may be understood more readily by reference to the following detailed description of the invention taken in connection with the accompanying drawing figures, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention. Any and all patents and other publications identified in this specification are incorporated by reference as though fully set forth herein.

Also, as used in the specification including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

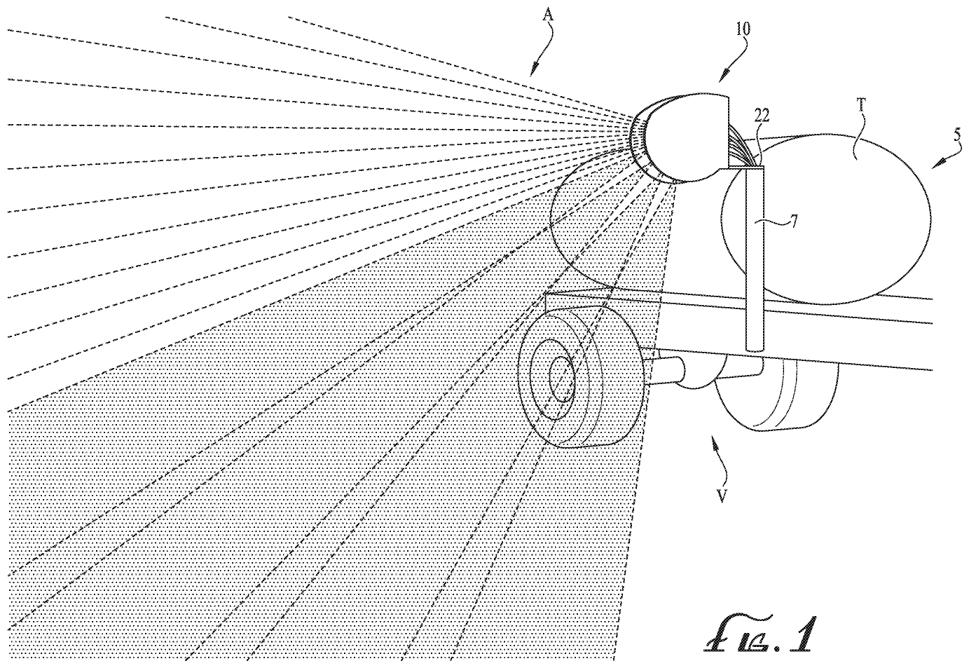

With reference now to the drawing figures, wherein like reference numbers represent corresponding parts throughout the several views, FIG. 1 shows a roadside spray apparatus 5 according to an example embodiment of the present invention. In example embodiments, the roadside spray apparatus 5 comprises a spray head assembly 10 that is mounted to a wheeled vehicle or other transportation device V, and a reservoir or tank T is mounted on the transportation device V for containing a quantity of liquid herbicide or other liquid. In example embodiments, the liquid contained within the tank T is moved through one or more conduits and discharged from the spray head assembly 10 to define a plurality of swaths A. In example embodiments, a pump (not shown) is provided and is interconnected between the tank T and spray head assembly 10 to transport the liquid to the spray head assembly 10 at a substantially high mass flow rate.

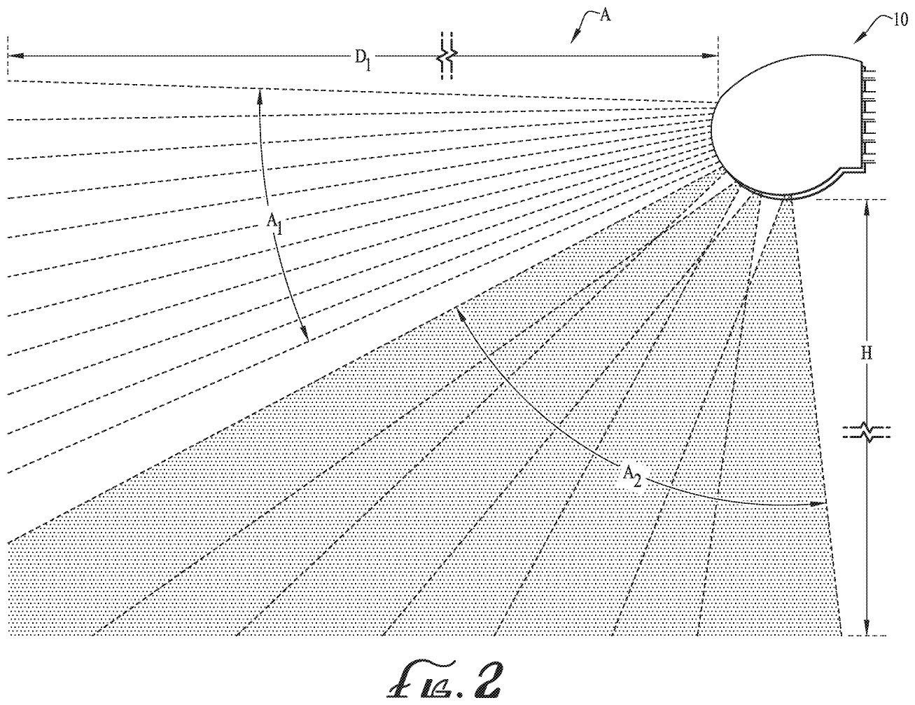

In example embodiments, the swaths A of liquid (e.g., herbicide in most cases) are preferably projected in a desired direction and distance so as to provide optimum coverage of a target area to be treated. According to some example embodiments, some of the swaths A are configured for only projecting a few feet from the spray head assembly in a generally vertical direction and other swaths A are configured for projecting outwardly at an angle or generally horizontal a plurality of feet from the spray head assembly 10. For example, as depicted in FIG. 2, the swaths A that are defined by the discharged liquid can comprise various forms. For example, swaths A1 define straight streams, for example, which are generally formed from a uniform single spray pattern and configured to project a distance D1. In example embodiments, the distance D1 can preferably be between about 1-200 feet, for example between about 1-100 feet according to one example embodiment. And swaths A2 define a flat spray pattern and can be configured to similarly project a distance D1, and for example, can be configured so as to be projected from a desired height H in a generally vertical direction and/or horizontal direction (e.g., or for example a combination of both vertical and horizontal).

In example embodiments, the swaths A2 are generally projecting towards a ground surface near the spray head assembly 10 and swaths A1 are projecting further away or outwards from the spray head assembly 10. In some example embodiments, the swaths A can project between 1-200 feet away from the spray head assembly 10. According to the depicted example embodiment, some of the swaths A (e.g., A1) are projecting about 20-35 feet away from the spray head assembly 10 prior to making impact with the ground, and for example, other swaths A (e.g., A2) travel between 2-15 feet before impacting the ground. According to example embodiments, the spray head assembly 10 comprises one or more spray nozzle assemblies mounted thereto so as to be adapted and configured for discharging the liquid (e.g., herbicide) therefrom in a desired direction, distance, and coverage, and without any concern for off-target drift.

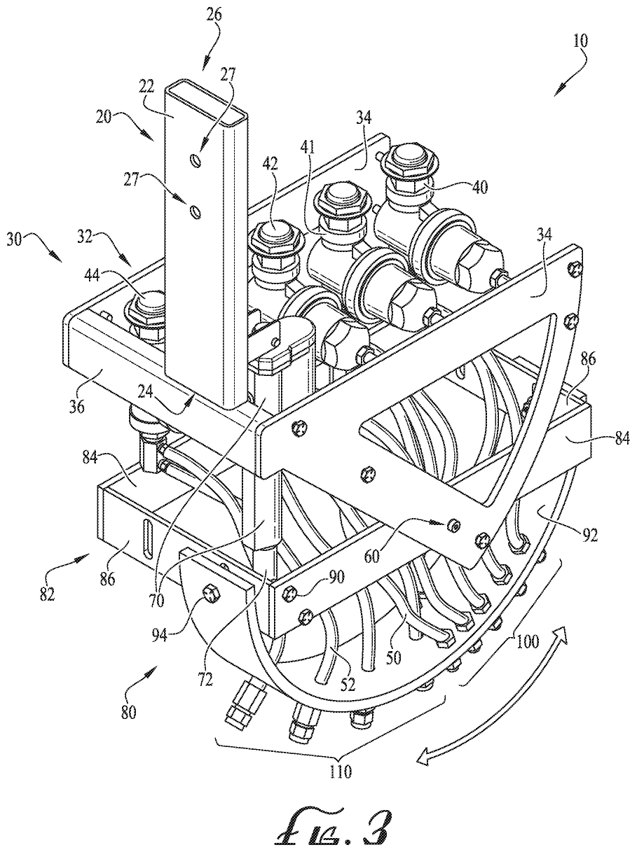

FIGS. 3-5 show the spray head assembly 10 in greater detail. In example embodiments, the spray head assembly 10 mounts to the vehicle V or other equipment and is connected to the tank T with one or more fluid fittings, hoses and/or other fluid conduits, etc. (see FIG. 1). As described above, a pump (not shown) is provided and is interconnected between the tank T and spray head assembly 10 to transport the liquid to the spray head assembly 10 at a substantially high mass flow rate.

In example embodiments, the spray head assembly 10 generally comprises a mounting portion 20, a distribution portion 30, and a nozzle head assembly 80. The mounting portion 20 comprises a generally elongate arm 22 comprising a first end 24 that is generally permanently mounted to a portion of the distribution portion 30 and a second end 26 that is generally extending a distance in a direction generally opposite the first end. Optionally, the first end 24 can be removably mounted to the distribution portion 30. As depicted in FIGS. 1-2, the spray head assembly can be provided with panels covering the sides of the assembly 10, for example such that the swaths A discharge from one or more components of the assembly 10 and generally from between the panels. In some example embodiments, the panels comprise a cutout or indicia for branding or marketing purposes. In some example embodiments, one or more utility lights or other roadway alert visual alerting components such as blinking lights, reflective material, etc. can be mounted to at least a portion of the assembly 10, for example which may include one or more of the panels.

In example embodiments, a pair of openings 27 are defined generally near the second end 26 in a spaced-apart manner, for example, extending through the entirety of the arm 22 so as to permit fasteners and/or other mounting components, hardware, clamps or other engagement mechanisms and/or features to permit engagement with the arm, for example, to mount the spray head assembly 10 according to one example embodiment. For example, according to example embodiments, two bolts are provided for extending through the openings 27 to mount the arm 22 (e.g., to the vehicle V or other desired location) in a generally horizontal orientation. Optionally, other fasteners, clamps, mechanisms, etc. can be provided for mounting the arm in any desired orientation. According to one example embodiment and as depicted in FIG. 1, a spray head assembly mount 7 extends generally upwards from a portion of the vehicle V, and for example, the arm 22 is mounted to a top portion of the mount 7 and generally maintains a generally horizontal orientation.

Preferably, as will be described in greater detail below, the nozzle head assembly 80 is preferably pivotally mounted to the distribution portion, for example, such that the nozzle head assembly 80 and registration plate thereof 92 pivot about an axis X.

In example embodiments, the distribution portion 30 comprises a frame assembly 32 comprising first and second side members 34 and a cross support 36 connecting at least a portion of each of the first and second side members 34 together. According to example embodiments, the first and second side members are generally triangular in shape, for example, wherein a first pair of like corners of the first and second side members 34 are connected by the cross support 36, a second pair of corners of the first and second side members 34 are pivotally connected to a frame assembly 82 of the nozzle head assembly 80 (e.g., via bolts 60), and a third pair of corners of the first and second side members 34 are configured to be connected together by a plate (unshown), for example, comprising a first portion that is sized and shaped to fill in the space defined between the first and second side members 34, and second and third portions extending generally transverse relative to the first portion. In example embodiments, the second and third portions of the plate are configured for mounting to the first and second side members 34.

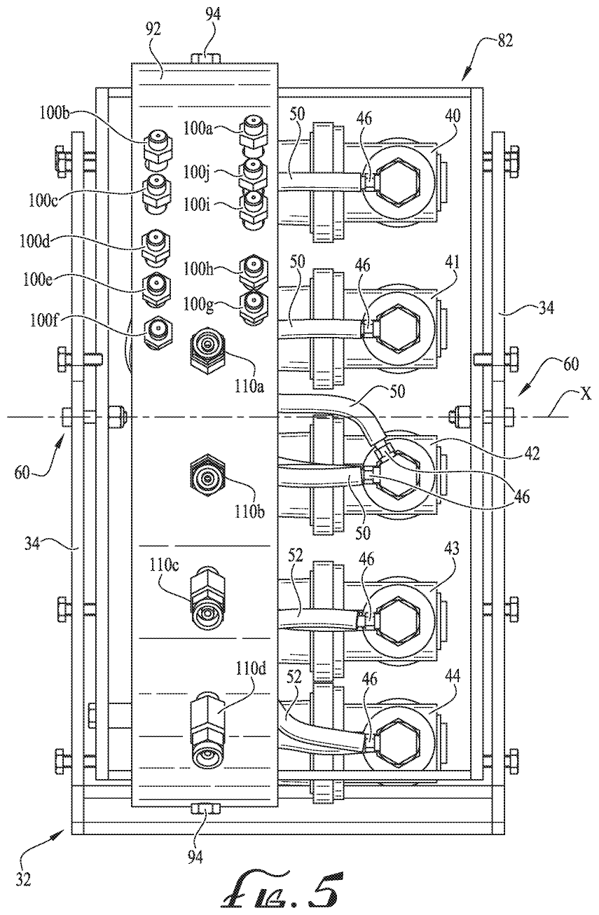

According to example embodiments, openings are formed in the first portion of the plate so as to receive at least a portion of each of the flow control units 40, 41, 42, 43, 44, for example, so as to provide a sturdy and efficient way to mount the flow control units so as to permit connectors, hoses and/or other coupling conduits to engage inlets of the flow control units 40, 41, 42, 43, 44. Furthermore, mounting the flow control units in this manner provides sufficient space for conduits or tubes 50, 52 to be mounted to outlet ports 46 of the flow control units, for example, thereby permitting a liquid to be delivered from the flow control units, through outlet ports 46 and tubes 50, 52, and through a first or second nozzle 100, 110 to be discharged therefrom (see FIG. 5). According to one example embodiment, the first portion of the plate comprises five openings that are sized to be securely engaged with at least a portion of each of the flow control units 40, 41, 42, 43, 44. According to one example embodiment, the threaded inlet connector (and threaded nut thereon) of each of the flow control units (see uppermost threaded portion of each of the flow control units of FIG. 3) is connected to the openings (respectively) in the plate, for example, so as to secure the flow control units to the distribution portion.

As best depicted in FIG. 5, each of the flow control units 40, 41, 42, 43, 44 comprise outlet ports 46, for example, which are configured to receive first and second tubes 50, 52 such that liquid can pass through the flow control units, through the outlet ports 46, through the tubes 50, 52, and through the first and second nozzles 100, 110 such that the liquid is discharged therefrom. As will be described in greater detail below, nozzles 100 are in the form of straight stream nozzles to define a single, uniform stream spray pattern. However, nozzles 110 are preferably in the form of air induction nozzles, for example, such that the chances of off-target drift occurring during a treatment (e.g., using the sprayer) is substantially minimal if not entirely eliminated.

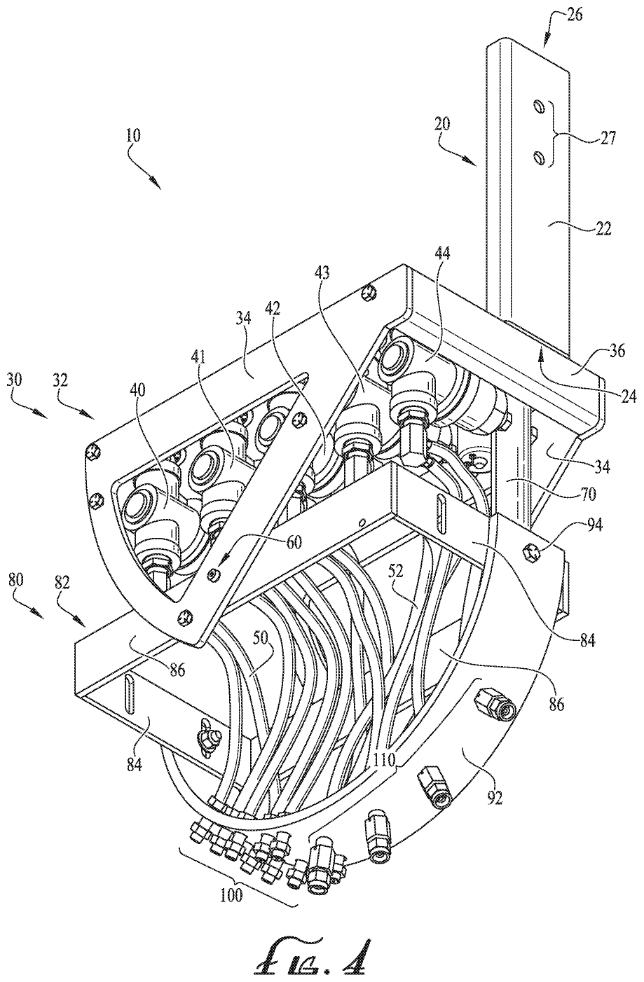

In example embodiments, the nozzle head assembly 80 comprises a frame assembly 82, side members 84, end members 86, and an arcuate registration plate 92 mounted to the frame assembly 82 (see FIGS. 3-4). In example embodiments, the arcuate registration plate 92 preferably provides a platform for receiving one or more of the first and second nozzles 100, 110.

As best seen in FIG. 5, the first nozzles 100a-j (straight stream nozzles) are generally grouped together in a spaced-apart and diagonally mirrored pattern so as to provide the swath A1 as depicted in FIG. 2. According to example embodiments, about ten straight stream nozzles 100a-j are mounted to predrilled openings in the registration plate 92 near an upper portion thereof. According to one example embodiment, on one side of a plane defined at a midpoint of the plate 92 along its long axis defines a linear array or generally straight grouping of three nozzles 100d, 100e, 100f that are spaced apart from a linear array or generally straight grouping of two nozzles 100b, 100c. In a similar manner, on an opposite side of the plane defined at a midpoint of the plate 92 along its long axis defines a linear array or generally straight grouping of two nozzles 100h, 100g that are spaced apart from a linear array or generally straight grouping of three nozzles 100a, 100j, 100i. Accordingly, the two nozzles 100h, 100g generally oppose or are on opposite sides of the plane relative to the three nozzles 100d, 100e, 100f. Similarly, the two nozzles 100b, 100c generally oppose or are on opposite sides of the plane relative to the three nozzles 100a, 100j, 100i. According to example embodiments, the pattern and grouping of the nozzles can be in the spaced-apart and diagonally mirrored pattern, for example wherein the similar quantity groupings are positioned on opposite sides of the midpoint and diagonal relative to each other.

Moving along the arcuate registration plate 92, the second nozzles 110a-d (air induction nozzles) are mounted to predrilled openings in the plate 92 to define a linear array of four air induction nozzles projecting outwardly along the arcuate surface defined by the plate 92. According to example embodiments, the nozzles 100a-d are configured to be positioned at the midpoint of the plate 92 along its long axis.

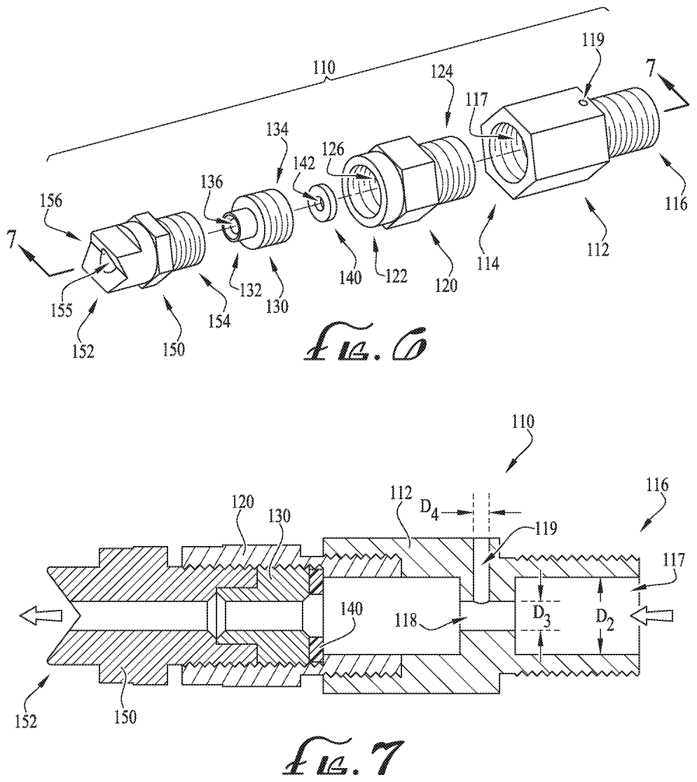

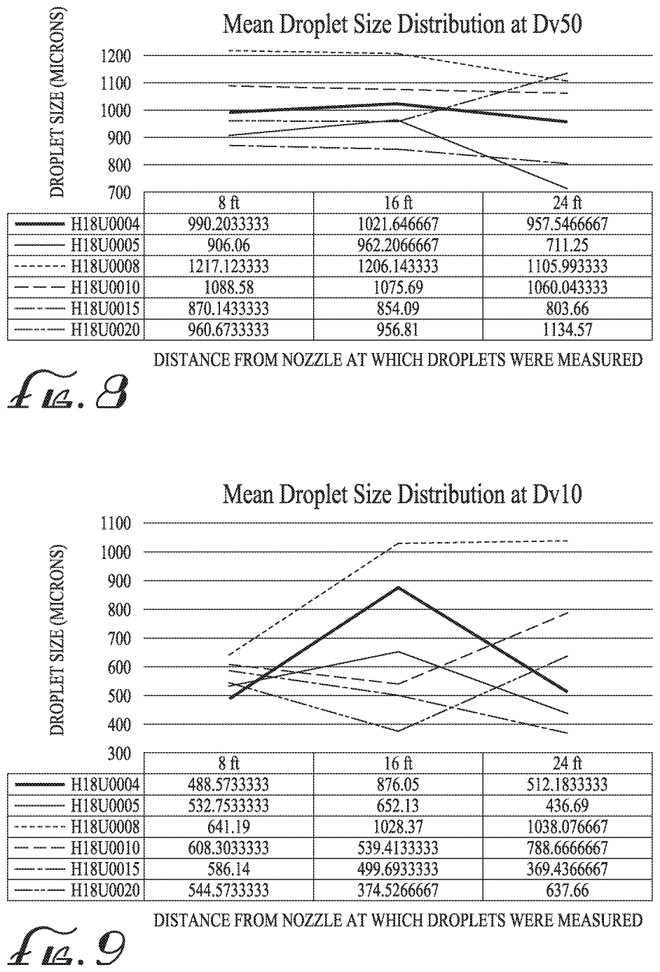

FIGS. 6-7 show the air induction nozzle 110 in greater detail. In example embodiments, the air induction nozzle 110 comprises a main body portion 112, a secondary body portion 120 and an inner reducer portion 130. Optionally, a washer or grommet 140 can be provided as will be described below. In example embodiments described herein (and used with the testing as described below), at least one of the air induction nozzles 110 further comprises a nozzle tip 150 in the form of a flat fan nozzle (Model #4U-4040). According to other example embodiments, the nozzle tip 150 can be configured to provide a desired spray pattern, for example, if it is determined that a spray pattern that is something other than a flat fan pattern is desired.

As depicted in FIG. 6, the main body portion 112 comprises a first end 114, a second end 116, and a conduit 117 extending therethrough. In example embodiments, a central conduit 118 (see FIG. 7) is provided and generally positioned at a midpoint of the main body portion 112 between the first and second ends 114, 116. Generally, the central conduit 118 comprises a smaller diameter than the conduit 117.

In example embodiments, the first end 114 of the main body portion 112 comprises an outer collar comprising internal threads and the second end 116 comprises a collar comprising external threads formed thereon. And the inner reducer portion 130 comprises a first end 132, a second end 134 and a conduit 136 extending therethrough. In example embodiments, an orifice 119 is configured to extend from an outer or external surface of the main body portion 112 to at least a portion of the central conduit 118. In example embodiments, the orifice 119 is positioned so as to be in communication with a low pressure area so as to allow for the introduction of air to the fluid flow, and thus, oxygenate the fluid flowing therethrough such that fluid droplets being dispersed from the nozzle tip 150 (attached to a first end 122 of the secondary body portion 120) output substantially large oxygenated fluid droplets with minimal atomization. In example embodiments, because of the reduced conduit portion 118 of the main body portion 112 and the inner reducer portion 130, the pressure therein drops such that the atmospheric pressure is greater, and thus, air is entrained within an orifice 119 of the main body portion 112 when a fluid is passing through the conduit of the venturi spray nozzle assembly 110 (see FIGS. 6-7).

According to example embodiments, the conduit 117 defined at the second end 116 of the main body portion 112 is sized to define a diameter D2, the central conduit 118 is sized to define a diameter D3, and the orifice 119 communicating between an external surface of the main body portion 112 and the central conduit 118 comprises a diameter D4. In example embodiments, the diameter D2 is generally between 0.2-0.5 inches, for example about 0.34 inches according to one example embodiment. The diameter D3 is generally between 0.025-0.330 inches, for example about 0.129 inches according to one example embodiment. And the diameter D4 of the orifice 119 is generally between about 0.01-0.2 inches, for example about 0.07 inches according to one example embodiment. Preferably, the diameter D3 of the central conduit 118 can be sized as desired, for example, less than or greater than 0.129 inches so as to control at least one aspect of the flow volume, for example, depending on the desired output goal or requirements.

In example embodiments, the secondary body portion 120 comprises a first end 122, a second end 124 and a conduit 126 extending therethrough. In example embodiments, the first end 122 comprises internal threads formed along a portion of the conduit 126 and the second end 124 comprises external threads for engagement with the internal threads of the first end 114 of the main body portion 112. In example embodiments, an externally threaded portion of the second end 134 of the inner reducer portion 130 is configured for connecting with the internal threaded portion of the secondary body portion 120. As depicted in FIG. 7, the washer or grommet 140 can optionally be sandwiched between the inner reducer portion 130 and an internal portion of the secondary body portion 120. Optionally, the inner reducer portion 130 can be secured to the secondary body portion 120 without the use of the grommet 140.

In example embodiments, the nozzle tip 150 comprises a first end 152, a second end 154 and a conduit 155 extending entirely therethrough. A v-shaped cutout or wedge-like reduction is provided at the first end 152 of the nozzle tip 150, for example, so as to provide a flat fan spray pattern. As described above, the nozzle tip 150 comprises an off-the-shelf nozzle (e.g., Model #4U-4040). As similarly described above, some example embodiments of the present invention comprise other nozzle tips connected to the first end of the secondary body portion 120.

In example embodiments, the air induction nozzles 110 are formed from a metal such as brass. According to another example embodiment, the venturi spray nozzle assemblies are formed from other metals, non-metals, plastics, composites, natural materials, synthetic materials, combinations thereof and/or other materials as desired. In a similar manner, any of the components of the roadside spray apparatus 5 and spray head assembly 10 thereof can be formed from any desired material, or for example, can be formed from a combination of two or more materials. According to some example embodiments, one or more components of the apparatus 5 and assembly 10 can be secured together by welding, fasteners, clips, clamps, mounts, clasps, bolts, screws, and/or any other desired mounting components, straps, bars, supports, braces, mechanisms, etc.

Referring back to FIG. 3, the nozzle head assembly 80 is preferably mounted to the distribution portion 30, for example, such that the nozzle head assembly 80, frame assembly 82 and registration plate thereof 92 pivot about an axis X (see FIG. 5) relative to the distribution portion 30. In example embodiments, bolts 60 or other pivot-like shafts or other members pivotally connect the frame assembly 82 with the second pair of corners of the first and second side members 34. In example embodiments, an electronically controlled actuator 70 (or other actuatable component) is mounted to mounting portion 20 and/or distribution portion 80 and a moving arm piece 72 is secured to an inside face of a side and/or end member 84, 86 by a fastener 90. In one example embodiment, a wired or wireless control can be provided so as to provide controlled, automated adjustability to the nozzle head assembly as desired.

Referring back to FIG. 5, the flow control units 40, 41, 42, 43 and 44 are preferably configured to provide the liquid (e.g., herbicide) to the nozzles 100, 110 (via the first and second nozzle tubes 50, 52) at a generally specific or desired pressure. For example, according to one example embodiment of the present invention, the flow control units 40, 41 and 42 supply liquid through each of the first nozzle tubes 50 to each of the first, straight stream nozzles 100a-j at 28 psi (lbs/in²) (e.g., 28 psi per tube) and flow control units 43, 44 supply liquid through each of the second nozzle tubes 52 to each of the second, air induction nozzles 110a-d at 50 psi (e.g., 50 psi per hose). In alternate example embodiments, the pressures can be adjusted as desired to provide a desired swath coverage.

For example, according to alternate example embodiments, the flow control units 40, 41 and 42 supply liquid through each of the first nozzle tubes 50 to each of the first, straight stream nozzles 100a-j between about 20-49 psi and flow control units 43, 44 supply liquid through each of the second nozzle tubes 52 to each of the second, air induction nozzles 110a-d between about 21-73 psi. In example embodiments, each of the flow control units 40, 41, 42, 43, 44 are generally configured to comprise a volumetric flow rate of about 3.75 gal/min. In other example embodiments, the volumetric flow rates of any of the flow control units 40-44 can be chosen as desired. According to one example embodiment, all the flow control units are configured to provide the same volumetric flow rate. According to another example embodiment, at least one of the flow control units comprises a volumetric flow rate that is different from the volumetric flow rates of the other flow control units. In another example embodiment, at least three of the flow control units comprise at least some difference with respect to their volumetric flow rate. In some example embodiments, the flow control units can be electronically controlled. According to some example embodiments, the spray head assembly 10 can be mounted to an articulating or movable arm or other mechanism as desired.

As described above, the swaths A2 produced from the second, air induction nozzles 110a-d can preferably be adjusted as desired. Preferably, the second, air induction nozzles 110a-d provide a plurality of benefits such as the introduction of air within the fluid, thereby allowing for the dispersion and discharge of substantially larger oxygenated fluid droplets with minimal atomization (as supported by the extensive testing procedure below). Thus, the present spray head assembly 10 comprising at least one or more second, air induction nozzles 110a-d preferably minimizes, if not entirely eliminates drift.

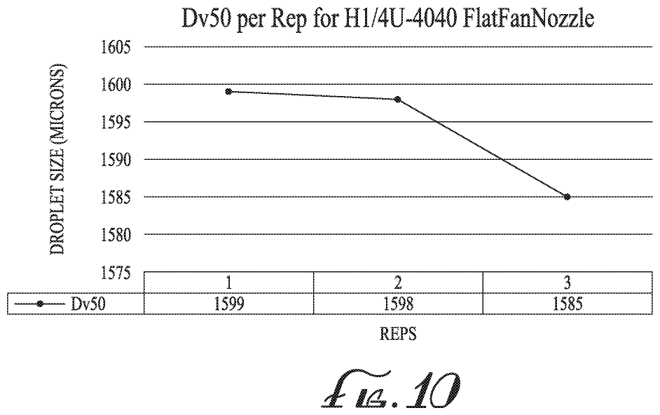

For example, extensive testing was conducted to measure the present invention's effectiveness in minimizing/eliminating drift. The testing was conducted in North Platte, Nebr. (University of Nebraska) by Mississippi State University. Furthermore, the present invention was tested in coordination (and in the presence of) the Environmental Protection Agency's (EPA) Drift Reduction Technology (DRT) Program to ensure the proper standards were met. FIG. 8 depicts a line chart of the mean droplet size distribution at Dv50 for the straight stream nozzles 100. FIG. 9 depicts a line chart of the mean droplet size distribution at Dv10 for the straight stream nozzles 100. FIG. 10 depicts a line chart of the mean droplet size distribution at Dv50 for the air induction nozzles 110 with the flat fan nozzle tip 150 attached thereto (Model #4U-4040 flat fan nozzle according to example embodiments).

According to testing methods. Dv50 is the droplet diameter for which 50% of the total spray volume is made up of droplets of equal or lesser diameter (average). Dv10 is the droplet diameter for which 10% of the total spray volume is made up of droplets of equal or lesser diameter (average). For agricultural spraying purposes, any droplets under 200 microns in size are considered most prone to drift. For agricultural testing, the goal is to have less than 0.7% of spray droplets at or below 141 microns. Accordingly, as depicted in the charts of FIGS. 8-10, testing showed results where 0.0% of droplets were at or below the 141 micron benchmark. This finding was true for all nozzles and distances. Accordingly, the testing conducted and disclosed herein clearly reveals that the present invention (and nozzles 100, 110 thereof) is not prone to drift (or for example off-target drift according to embodiments). In example embodiments, the testing results as documented herein have been shared with the EPA and the conductors of the program

According to another example embodiment, the present invention relates to a method of applying a fluid to a ground surface. According to example embodiments, the method comprises 1) providing a roadside spray apparatus, the roadside spray apparatus comprising a mounting portion, a distribution portion, and a nozzle head assembly pivotally mounted to the distribution portion; 2) providing at least one air induction nozzle for attachment to the nozzle head assembly; 3) providing at least one straight stream nozzle for attachment to the nozzle head assembly, the straight stream nozzle being at least partially spaced apart from the air induction nozzle; 4) fluidly connecting the at least one air induction nozzle and at least one straight stream nozzle to the distribution portion; 5) fluidly connecting the distribution portion to a pump, the pump fluidly connected to a tank comprising a liquid; 6) mounting the roadside spray apparatus to a wheeled vehicle; and 7) pumping the liquid from the tank, through the pump, to the distribution portion, and further through the at least one air induction nozzle and the at least one straight stream nozzle so as to produce at least two swaths of the liquid.

While the invention has been described with reference to preferred and example embodiments, it will be understood by those skilled in the art that a variety of modifications, additions and deletions are within the scope of the invention, as defined by the following claims.

What is claimed is:

1. A roadside spray apparatus comprising:
a mounting portion;
a distribution portion connected to the mounting portion; and
a nozzle head assembly pivotally mounted to the distribution portion,
wherein an actuator connects between the mounting portion and/or distribution portion and the nozzle head assembly such that extension and retraction of the actuator causes pivoting of the nozzle head assembly.

2. The roadside spray apparatus of claim 1, wherein the nozzle assembly comprises a frame assembly and an arcuate registration plate mounted to the frame assembly, the registration plate comprising one or more nozzles connected therewith, wherein at least one of the one or more nozzles comprises an air induction nozzle.

3. The roadside spray apparatus of claim 2, wherein at least one of the one or more nozzles comprises a straight stream nozzle.

4. The roadside spray apparatus of claim 2, further comprising a spray nozzle attached to the end of the at least one air induction nozzle, the spray nozzle comprising a flat spray pattern.

5. The roadside spray apparatus of claim 2, wherein the air induction nozzle produces a total spray volume for which at least about 50% thereof comprises droplets of equal or lesser diameter than between about 1500-1800 microns.

6. The roadside spray apparatus of claim 5, wherein the total spray volume for which at least about 50% thereof comprises droplets of equal or lesser diameter than between about 1550-1600 microns.

7. The roadside spray apparatus of claim 6, wherein the total spray volume for which at least about 50% thereof comprises droplets of equal or lesser diameter than between about 1585-1599 microns.

8. The roadside apparatus of claim 3, wherein the straight stream nozzle produces a total spray volume for which at least about 50% thereof comprises droplets of equal or lesser diameter than between about 700-1220 microns.

9. The roadside apparatus of claim 3, wherein the straight stream nozzle produces a total spray volume for which at least about 10% thereof comprises droplets of equal or lesser diameter than between about 360-1050 microns.

10. The roadside spray apparatus of claim 2, wherein the registration plate comprises four air induction nozzles and ten straight stream nozzles.

11. The roadside spray apparatus of claim 2, wherein the at least one air induction nozzle is generally mounted to the registration plate along a plane that is generally at the midpoint of its lengthwise dimension.

12. The roadside spray apparatus of claim 10, wherein the straight stream nozzles are generally mounted to the arcuate registration plate generally near each other in groups of between two to four, wherein at least two groups of straight stream nozzles mount along at least a portion of the arcuate registration plate, wherein the at least two groups of straight stream nozzles are spaced relative to each other and also spaced apart from the air induction nozzles.

13. A venturi spray nozzle assembly comprising:
a main body portion, the main body portion comprising a conduit extending therethrough;
an inner reducer portion, the inner reducer portion comprising a conduit extending therethrough, the inner reducer portion being configured for fitting within at least a portion of the conduit of the main body portion; and
a secondary body portion comprising a first end and a second end and a conduit extending therethrough, the first end of the secondary body portion being configured for coupling engagement with an end of the main body portion so as to contain the inner reducer portion within the conduit of the main body portion,
wherein the main body portion comprises an orifice so as to permit the entrance of a gas within the conduit of the conduit of the main body portion.

14. The venturi spray nozzle of claim 3, wherein with a fluid being pumped through the conduits at a substantially high flow rate, air is pulled through the orifice and mixed together with the fluid flowing therethrough so as to output substantially large oxygenated fluid droplets with minimal atomization.

15. The venturi spray nozzle of claim 14, further comprising a washer or gasket positioned between the inner reducer portion and the conduit of the main body portion.

16. The venturi spray nozzle of claim 13, further comprising a spray nozzle attached to the second end of the secondary body portion, the spray nozzle comprising a flat spray pattern.

17. The venturi spray nozzle of claim 13, wherein the air induction nozzle produces a total spray volume for which at least about 50% thereof comprises droplets of equal or lesser diameter than between about 1550-1600 microns.

18. The venturi spray nozzle of claim 17, wherein the total spray volume for which at least about 50% thereof comprises droplets of equal or lesser diameter than between about 1585-1599 microns.

19. The venturi spray nozzle of claim 17, further comprising at least one straight stream nozzle, the straight stream nozzle producing a total spray volume for which at least about 50% thereof comprises droplets of equal or lesser diameter than between about 700-1220 microns.

20. The venturi spray nozzle of claim 17, further comprising at least one straight stream nozzle, the straight stream nozzle producing a total spray volume for which at least about 10% thereof comprises droplets of equal or lesser diameter than between about 360-1050 microns.

21. A method of applying a fluid to a ground surface comprising:
providing a roadside spray apparatus, the roadside spray apparatus comprising a mounting portion, a distribution portion, and a nozzle head assembly pivotally mounted to the distribution portion;
providing at least one air induction nozzle for attachment to the nozzle head assembly;
providing at least one straight stream nozzle for attachment to the nozzle head assembly, the straight stream nozzle being at least partially spaced apart from the air induction nozzle;
fluidly connecting the at least one air induction nozzle and at least one straight stream nozzle to the distribution portion;
fluidly connecting the distribution portion to a pump, the pump fluidly connected to a tank comprising a liquid;
mounting the roadside spray apparatus to a wheeled vehicle; and
pumping the liquid from the tank, through the pump, to the distribution portion, and further through the at least one air induction nozzle and the at least one straight stream nozzle so as to produce at least two swaths of the liquid.
